(19) United States
(12) Patent Application Publication
(10) Pub. No.: US 2008/0150730 A1
(43) Pub. Date: Jun. 26, 2008

(54) Infant remote monitoring system

(76) Inventor: Cheung-Hwa Hsu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/641,685

(22) Filed: Dec. 20, 2006

(51) Int. Cl. G08B 23/00

(52) U.S. Cl. 340/573.1; 340/584

(57) ABSTRACT

An infant remote monitoring system utilizes a heat detector to monitor the baby temperature from breath to prevent from the Sudden Infant Death Syndrome (SIDS).

### BACKGROUND OF THE INVENTION

1. Field of the Invention

The present invention relates to an infant remote monitoring system, in particular to a system to monitor the heat from the breath of a baby so that to prevent the Sudden Infant Death Syndrome caused by asphyxia.

2. Description of the Prior Art

In order to prevent baby from SIDS, some hospitals or families use an asphyxia monitor system to monitor infants' movement. There are so many monitors on the market for that particular purpose. Most of them utilize electronic plates, one of which is Corometrics Infant Monitor model 502, as shown in FIG. 4, which uses two to three electronic plates 5 attached to the underneath or nearby of the nipples of a baby 4, through the electronic plates 5 to detect the pulse and breath. The electronic plates 5 may irritate the baby's skin. The electronic plates 5 should be cleaned each time before use in order to acquire accurate readings. The wires, the electronic plates 5 and all contacting points should be checked carefully in order to avoid electric shock.

Another conventional product is Little Sentry Junior CAN101 of GORMO company, as shown in FIG. 5, which is to install all electronic plates SA into a blanket 6 and is secured to the position where the baby's chest will be to detect the baby's chest movement when breathing. This design is very fragile and too sensitive, if the baby is too light in weight, the signal may not be accurate. If the baby is too heavy, the electronic plates 5A may be damaged easily. The system may also detect a false signal with the baby's movement.

Another conventional product, as shown in FIG. 6, is an air mattress 8. A sensor 81 is connected with the air mattress 8. The sensor 81 is then connected to a monitor 7. With a baby 4 laid on the air mattress 8, the breath of the baby 4 will cause the air in the air mattress 81 to move up and down, the movement of the air mattress 81 will be detected by the sensor 81, should the breath stops over the predetermined time, a warning siren will be triggered. The sensitivity and precision depend on the pressure of the air mattress 8.

### SUMMARY OF THE INVENTION

According to the present invention, there is provided with an infant remote monitoring system comprising a sensor unit, a control unit, and a warning device. The sensor unit includes a heat detector and a supporting canopy. The heat detector is displayed in the supporting canopy. The supporting canopy is provided with an adjusting rod and is in an arcuate shape so that when covering a baby, the heat detector will face to the baby's breathing organ directly. The heat detector of the sensor unit is connected to the control unit which then is connected to the warning device. The warning device comprises a voice warning speaker, a personal computer and a nursing station. By the heat detector, the present invention is to provide a timely warning when the baby's breath is detected in an abnormal condition to prevent the Sudden Infant Death Syndrome (SIDS).

### BRIEF DESCRIPTION OF THE DRAWINGS

FIG. 1 is a block diagram of a preferred embodiment of the present invention;

FIG. 2 is a perspective view of the preferred embodiment of the present invention;

FIG. 3 is a side view of the preferred embodiment of the present invention in an operating status;

FIG. 4 is a perspective view showing electronic plates of the prior art.

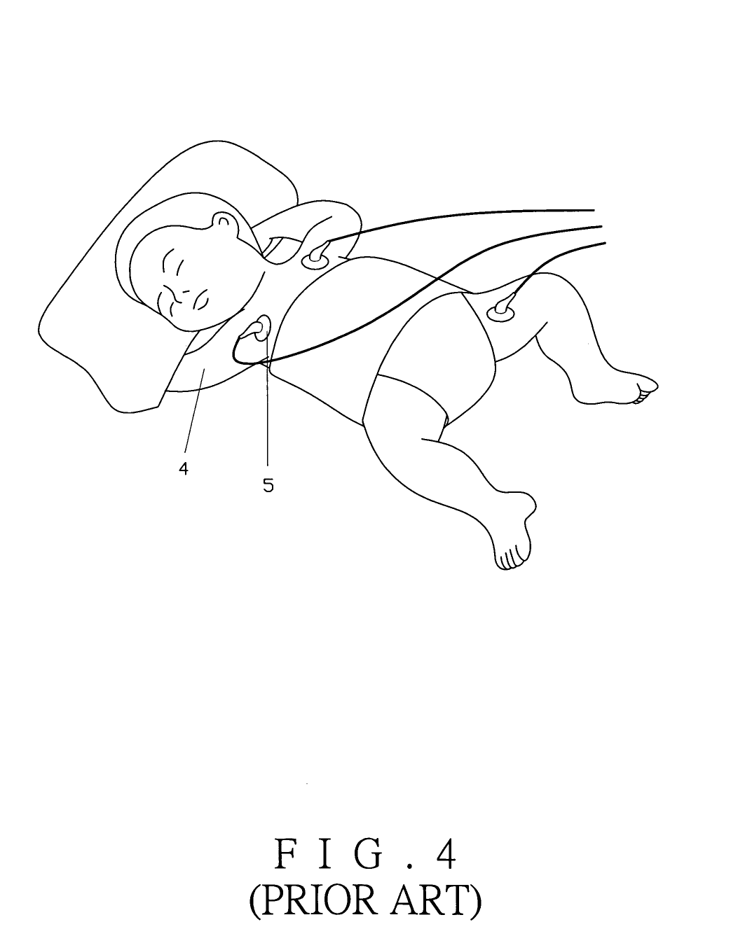

FIG. 5 is a perspective view showing a blanket of the prior art with electronic plates embedded therein; and

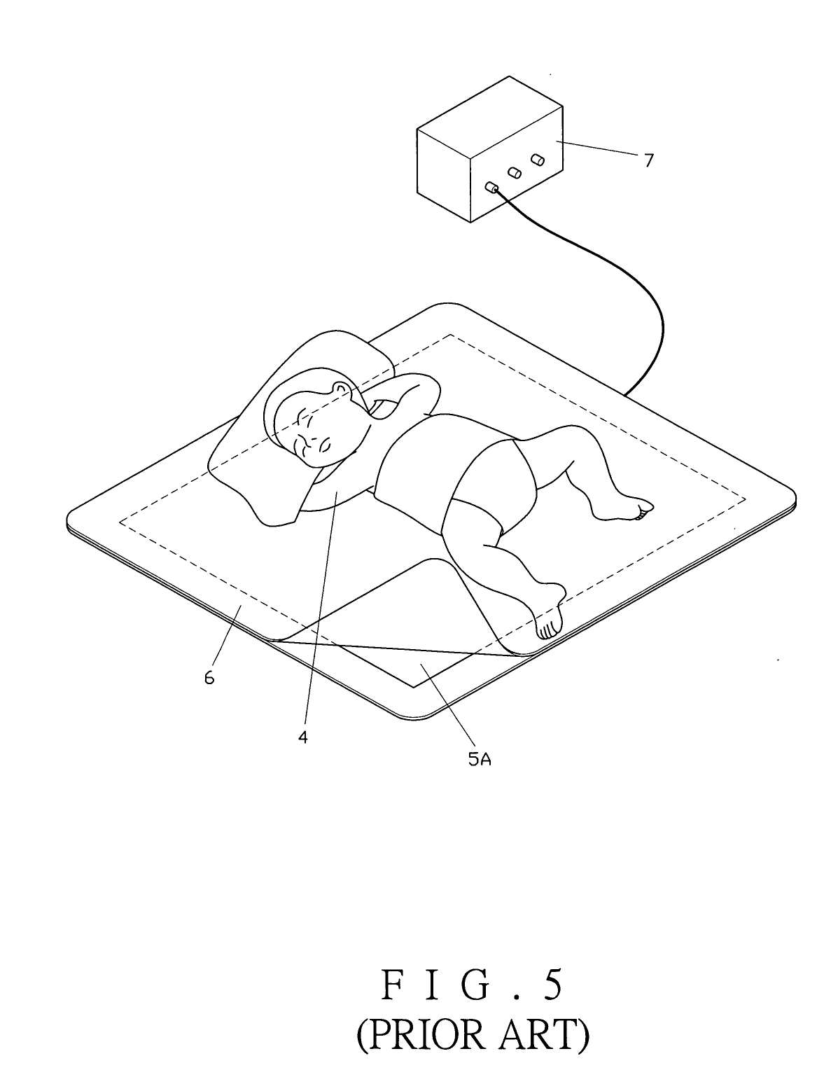

FIG. 6 is an air mattress of the prior art.

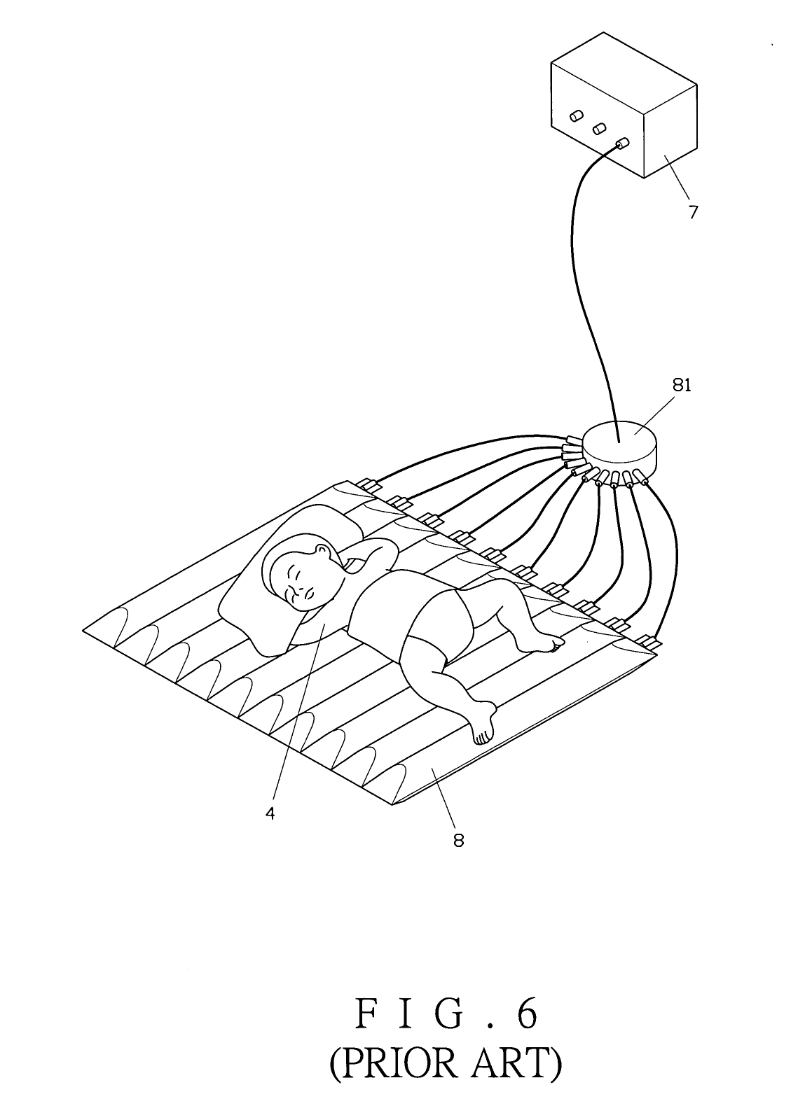

### DETAILED DESCRIPTION OF THE PREFERRED EMBODIMENT

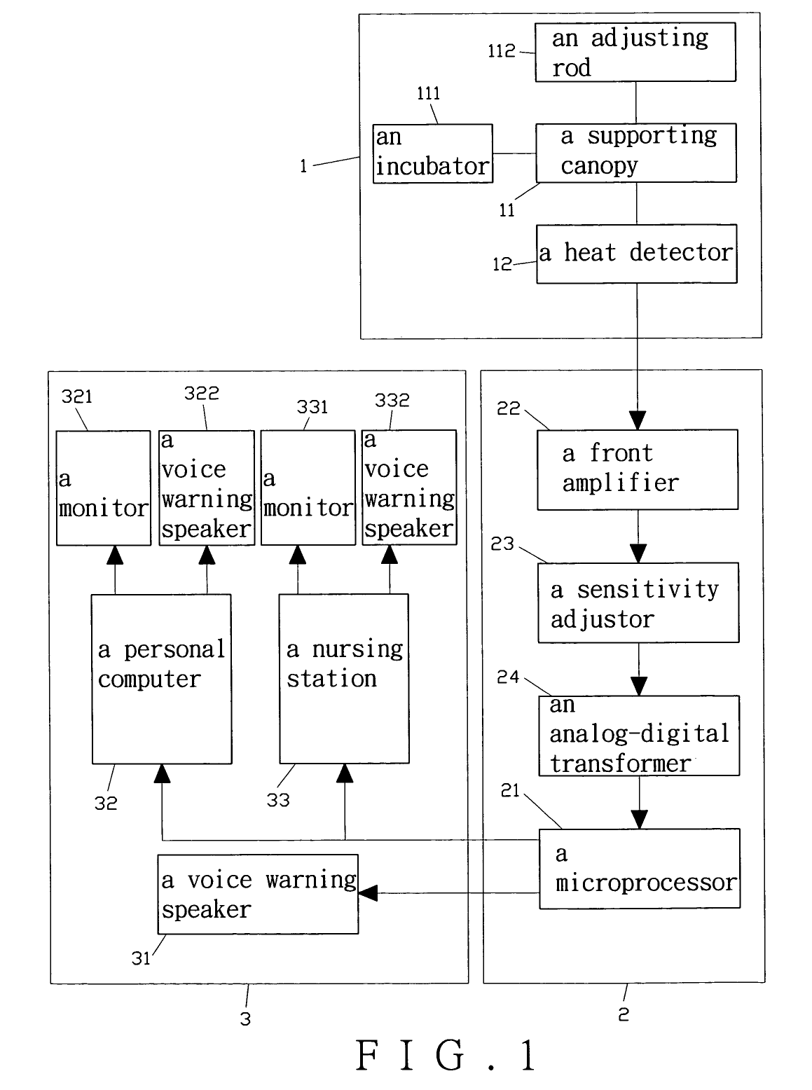

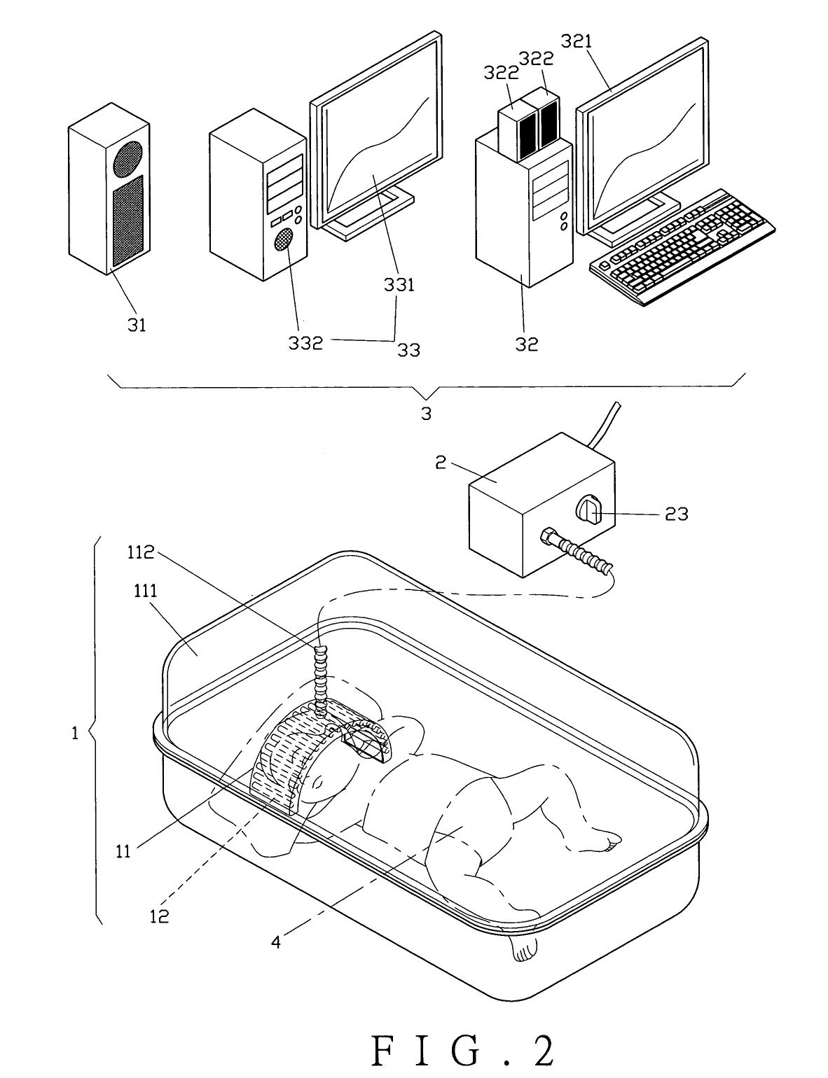

As shown in FIGS. 1 and 2, a preferred embodiment of the present invention comprises a sensor unit 1, a control unit 2, and a warning device 3.

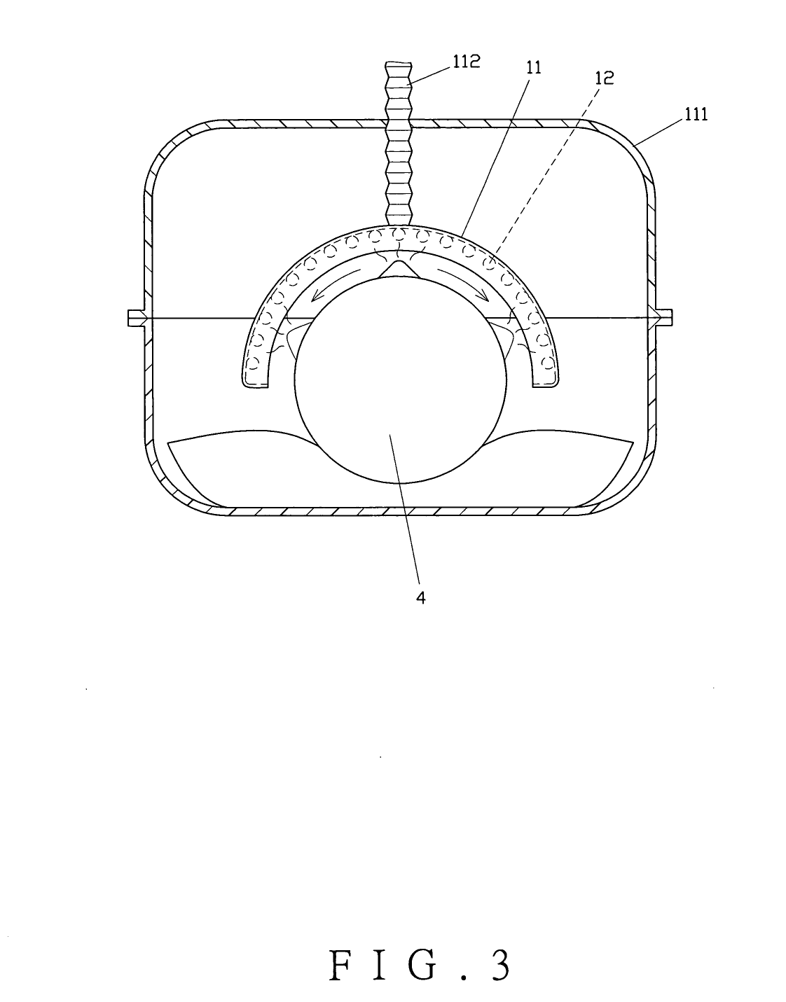

The sensor unit 1 comprises a supporting canopy 11 and a heat detector 12. The supporting canopy 11 is in an arcuate shape and provided with an adjusting rod 112 to adjust the angle and position of the supporting canopy 11 in relation to the baby. The heat detector 12 is composed of a plurality of heat resistances deployed in the supporting canopy 11. As shown in FIG. 3, the supporting canopy 11 is disposed in an incubator 111. The heat detector 12 deployed in the supporting canopy 11 faces directly to the baby's breath organ. The heat detector 12 of the sensor unit 1 is connected to the control unit 2. The control unit 2 is connected to the warning device 3.

The control unit 2 comprises a microprocessor 21, a front amplifier 22, a sensitivity adjustor 23 and an analog-digital transformer 24. The front amplifier 22 amplifies the signal received from the heat detector 12. The sensitivity adjustor 23 adjusts the sensitivity of the sensor unit 1. The analog-digital transformer 24 switches the signal type.

The warning device 3 comprises a voice warning speaker 31, a personal computer 32 and a nursing station 33. The personal computer 32 comprises a monitor 321 and a voice warning speaker 322. The nursing station 33 comprises a monitor 331 and a voice warning speaker 332.

When operating the present invention, the supporting canopy 11 is to cover the baby's head, as shown in FIG. 3. In this embodiment, the supporting canopy 11 is placed in the incubator 111. The supporting canopy 11 is adjusted with the adjusting rod 112 to the most appropriate position so that the heat detector 12 faces directly to the breath organ of a baby 4. The sensitivity adjustor 23 of the control unit 2 may help the user to adjust the heat detector 12 to the best position as well.

What is claimed is:

1. An infant remote monitoring system comprising a sensor unit, a control unit, and a warning device, said sensor unit comprising a heat detector and an arcuate supporting canopy, said heat detector being deployed in said supporting canopy in such a way that upon said supporting canopy is placed on a baby's head, said heat detector facing directly to the breath organ of the baby, said heat detector of said sensor unit being connected to said control unit, said control unit being connected to said warning device.

2. The infant remote monitoring system, as recited in claim 1, wherein said heat detector is composed of a plurality of heat resistances.

3. The infant remote monitoring system, as recited in claim 1, wherein said supporting canopy comprises an adjusting rod adapted to adjust the angle and position of said supporting canopy.

4. The infant remote monitoring system, as recited in claim 1, wherein said control unit comprises a microprocessor.

5. The infant remote monitoring system, as recited in claim 1, wherein said warning device comprises a voice warning speaker.

6. The infant remote monitoring system, as recited in claim 1, wherein said warning device comprises a monitor.

7. The infant remote monitoring system, as recited in claim 6, wherein said warning device comprises a personal computer.

8. The infant remote monitoring system, as recited in claim 6, wherein said personal computer of said warning device comprises a monitor.

9. The infant remote monitoring system, as recited in claim 6, wherein said personal computer of said warning device comprises a voice warning speaker.
